(19) United States
(12) Patent Application Publication
(10) Pub. No.: US 2024/0370525 A1
(43) Pub. Date: Nov. 7, 2024

(54) MULTI-PERIOD DYNAMIC COVARIANCE ESTIMATION OF TIME SERIES

(71) Applicants: INTERNATIONAL BUSINESS MACHINES CORPORATION, ARMONK, NY (US); Massachusetts Institute of Technology, Cambridge, MA (US)

(72) Inventors: Yada Zhu, Irvington, NY (US); Wenyu Chen, Cambridge, MA (US); Riade Benbaki, Cambridge, MA (US); Rahul Mazumder, Somerville, MA (US)

(21) Appl. No.: 18/312,446

(22) Filed: May 4, 2023

(51) Int. Cl. G06F 17/16; G06F 17/18

(52) U.S. Cl. CPC G06F 17/16; G06F 17/18

(57) ABSTRACT

A method for estimating a dynamic covariance matrix includes establishing component covariance matrices respectively for time periods of the dynamic covariance matrix. The method further includes decomposing each component covariance matrix of the component covariance matrices into a low-rank part and a sparse part to generate optimization functions of the component covariance matrices, combining the optimization functions to generate a multi-period joint optimization function of the dynamic covariance matrix, and regularizing the multi-period joint optimization function according to structural assumptions of smooth variations in covariances across the time periods to generate an objective function. The objective function is solved using a scalable algorithm to estimate the dynamic covariance matrix.

### BACKGROUND

The present disclosure relates generally to covariance matrix estimations and, more particularly, to dynamic covariance matrix estimation of series of data for multiple time periods.

Covariance matrix estimation is useful for solving statistics or random variables related problems, such as for applications in finance, economics, biology, machine learning, social networks, health science and other applications. A covariance is an indicator of the extent to which two random variables are varying together. A zero covariance value indicates no dependency between two variables and a higher covariance value indicates a higher dependency. For example, in finance applications, covariance matrices identify dependency relationships between different entities of financial markets which can be useful to diversify assets in a portfolio of investments. A covariance matrix can be a dynamic covariance matrix of time-varying covariances or a static covariance matrix of stationary covariances that do not change significantly over time.

### SUMMARY

A method for estimating a dynamic covariance matrix of time series for multiple time periods includes establishing component covariance matrices respectively for time periods of the dynamic covariance matrix. The method further includes decomposing each component covariance matrix of the component covariance matrices into a low-rank part and a sparse part to generate optimization functions of the component covariance matrices, combining the optimization functions to generate a multi-period joint optimization function of the dynamic covariance matrix, and regularizing the multi-period joint optimization function according to structural assumptions of smooth variations in covariances across the time periods to generate an objective function. According to the method, the objective function is then solved using a scalable algorithm to estimate the dynamic covariance matrix.

A system for estimating dynamic covariance matrix of time series for multiple time periods is disclosed. The system includes a non-transitory computer-readable storage memory configured to store instructions. The system further includes a processor coupled to the non-transitory computer-readable storage memory. The processor is configured to execute the instructions to cause the system to generate optimization functions of component covariance matrices for respective time periods based on a factor model of multivariate time series including a low-rank part and a sparse part, combine the optimization functions to generate a multi-period joint optimization function of a dynamic covariance matrix across the time periods, generate an objective function by regularizing the multi-period joint optimization function according to structural assumptions of smooth changes across the time periods, and estimate the dynamic covariance matrix by solving the objective function using a scalable algorithm.

A computer program product for estimating dynamic covariance matrix of time series for multiple time periods is also disclosed. The computer program product comprises instructions stored on a non-transitory computer-readable medium. When executed by a processor, the stored instructions cause a system to receive data of time series for different time periods, generate optimization functions of component covariance matrices of the time series, each of the component covariance matrices being decomposed into a low-rank part and a sparse part for a respective time period of the time periods. The instructions further cause the system to generate a multi-period joint optimization function of a dynamic covariance matrix as a combination the optimization functions, impose a discrepancy metric on the multi-period joint optimization function according to structural assumptions of smooth changes across the time periods to obtain an objective function for the dynamic covariance matrix, and solve the objective function using a block coordinate descent (BCD) based algorithm to estimate the dynamic covariance matrix.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram illustration of a system for dynamic covariance matrix estimation in accordance with aspects of the present disclosure.

FIG. 2 is a flowchart illustration of a method for dynamic covariance matrix estimation in accordance with aspects of the present disclosure.

FIG. 3 is a block diagram illustration of a system for optimizing a portfolio using dynamic covariance matrix estimation in accordance with aspects of the present disclosure.

FIG. 4 is a graph illustrating volatility-return curves for different values of expected return of a portfolio in accordance with an embodiment of the present disclosure.

FIG. 5 is a block diagram illustration of a hardware architecture of a computing system in accordance with aspects of the present disclosure.

The illustrated figures are only exemplary and are not intended to assert or imply any limitation with regard to the environment, architecture, design, or process in which different embodiments may be implemented.

### DETAILED DESCRIPTION

It should be understood at the outset that, although an illustrative implementation of one or more embodiments are provided below, the disclosed systems, computer program product, and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

As used within the written disclosure and in the claims, the terms “including” and “comprising” (and inflections thereof) are used in an open-ended fashion, and thus should be interpreted to mean “including, but not limited to.” Unless otherwise indicated, as used throughout this document, “or” does not require mutual exclusivity, and the singular forms “a,” “an,” and “the” are intended to include the plural forms as well, unless the context clearly indicates otherwise.

A “module” or “unit” (and inflections thereof) as referenced herein comprises one or more hardware or electrical components such as electrical circuitry, processors, and memory that may be specially configured to perform a particular function. The memory may comprise volatile memory or non-volatile memory that stores data such as, but not limited to, computer executable instructions, machine code, and other various forms of data. The module or unit may be configured to use the data to execute one or more instructions to perform one or more tasks. In certain instances, a module or unit may also refer to a particular set of functions, software instructions, or circuitry that is configured to perform a specific task. For example, a module or unit may comprise software components such as, but not limited to, data access objects, service components, user interface components, application programming interface (API) components; hardware components such as electrical circuitry, processors, and memory; and/or a combination thereof. As referenced herein, computer executable instructions may be in any form including, but not limited to, machine code, assembly code, and high-level programming code written in any programming language.

Also, as used herein, the term “communicate” (and inflections thereof) means to receive and/or transmit data or information over a communication link. The communication link may include both wired and wireless links, and may comprise a direct link or may comprise multiple links passing through one or more communication networks or network devices such as, but not limited to, routers, firewalls, servers, and switches. The communication networks may comprise any type of wired or wireless network. The networks may include private networks and/or public networks such as the Internet. Additionally, in some embodiments, the term communicate may also encompass internal communication between various components of a system and/or with an external input/output device such as a keyboard or display device.

For various applications, the covariances between random variables that vary across time can be represented by a dynamic covariance matrix. The covariances can be estimated for a series of random variables obtained at successive time instances with equal intervals, also referred to as time series. Examples of time series include stock prices, sales data, inventory data, logistics data, weather data, rainfall measurements, temperature readings, monitored health data, or other data collected across time instances in equal intervals. The estimated dynamic covariance matrix can be used to process, decorrelate, transform, or identify relationships between data in applications.

Examples of covariance matrix uses include decoding radio signals in radio engineering, removing noise from signals in acoustics, obtaining dependencies between gene expressions in genomics, mapping out virus influences in cancer research, detecting vibration damages in civil engineering, detecting temperature trends in climatology, designing videos game in entertainment technology, detecting pixels in image recognition, calibrating brain-computer interfaces in neuroscience, modeling mental health patterns in psychology, developing braking assistance in automotive engineering, and transcription of conversation in speech recognition.

In finance, a dynamic covariance matrix can be used to optimize a portfolio of investments in financial assets, such as stocks, bonds, money markets, cash, commodities, or other financial assets. The portfolio is optimized by optimizing an objective function of the dynamic covariance matrix, such as maximizing expected returns and/or minimizing variances of returns.

Embodiments of the present disclosure provide systems and methods to estimate a dynamic covariance matrix for time series. The dependency relationships between different entities or sources of the time series can vary across time periods. The dynamic matrix is represented by component covariance matrices for the respective time periods and is estimated by estimating the component covariance matrices simultaneously. The component covariance matrices can be static covariance matrices, where the dependency relationships between different entities in the respective time periods is assumed to be static or quasi-static. The component covariance matrices can be simultaneously estimated with assumptions related to the structure and the time-varying characteristics of the covariance matrices. Estimating static covariance matrices simultaneously based on structural and time-varying characteristic assumptions reduces the complexity of the dynamic covariance matrix estimation, which can increase estimation accuracy and calculation time efficiency compared to estimating the dynamic covariance matrix as single covariance matrix across the time periods.

Increasing the estimation accuracy of the dynamic covariance matrix also improves the optimization of applications that use the dynamic covariance matrix. For example, increasing the estimation accuracy of the dynamic covariance matrix estimation for finance data improves portfolio optimization of related investments. In other examples, the dynamic covariance matrix is estimated for economics data, health data, marketing data, Internet data, science data, social networks data, weather/atmospheric data, traffic data, energy data, behavioral data, or other collected data over time in other applications.

For static models that do not vary significantly over time, covariance matrix estimation is based on assumptions that past data correlations represent future data correlations. Such assumptions may not be suitable in applications with significant changes over time. For example, for finance data of financial markets, such assumptions can result in significantly underestimated portfolio risk when market regimes shift. Time-varying models for covariance matrix estimation are based on estimation methods that use parametric models such as generalized autoregressive conditional heteroskedasticity (GARCH) models, or non-parametric/semi-parametric models such as kernel regression or smoothing models.

Estimation methods can complicate the use of structural and time characteristic assumptions on component covariance matrices. For example, model training, also referred to as learning, in such estimation methods involves algorithms that require more processing time as the dimensions of covariance matrices become larger. Examples of such algorithms include expectation-maximization (EM) algorithms, multi-stage separate learning, or Bayesian type Markov chain Monte Carlo (MCMC) approaches. The learning process includes iterative steps of calculations until reaching an acceptable convergence in the estimated values.

According to embodiments of the disclosure, the joint optimization for simultaneously learning the component covariance matrices of a dynamic covariance matrix can be performed using scalable algorithms with higher calculation time efficiency (i.e., faster calculation time) than other estimation methods that use parametric or non-parametric/semi-parametric models. For example, the convergence time to learn the component covariance matrices simultaneously can be faster on an order of multiple magnitudes than other estimation methods.

The scalable algorithms for the joint optimization can also have higher estimation accuracy than other methods. In various applications, the sample size of data can be limited relative to the number of parameters for covariance matrix estimation and accordingly relative to the dimensions of the covariance matrix. The limited sample size can cause instability or reduce the accuracy of calculations for covariance matrix estimation. For static covariance matrix estimation, the limited sample size can be accounted for with regularization models, also referred to as regularizers, such as low-rank factor models, sparsity models, or a combination of both. In comparison, the number of parameters can be greater in time-varying models and accordingly the sample size can be more limited for the dynamic covariance matrix estimation.

In embodiments of the disclosure, the dynamic covariance matrix is estimated with different structural assumptions for the component covariance matrices including for low-rank and sparsity. For each time period, a respective component covariance matrix can be decomposed into a low-rank matrix and a sparse matrix. The low-rank and sparse matrices of the respective time periods can be learned simultaneously by solving the joint optimization problem using the scalable algorithms. The dynamic covariance matrix is also estimated with further assumptions using regularizers that enforce a slow/sparse varying pattern across the covariances to simplify calculations. The regularizers control the amount of change in the values of the covariances over time periods.

According to the embodiments, the dynamic covariance estimation can provide higher calculation time efficiency, estimation accuracy, and accordingly improved application optimization in comparison to other estimation methods and off-the-shelf optimization solvers. The various, models, algorithms, processes, and methods for dynamic covariance matrix estimation can be implemented in the form of computer instructions or software programs, using a centralized or distributed computer/processing system. For example, the dynamic covariance matrix can be performed as software executed by a computer system such as a desktop or a laptop computer, or by a server such as a cloud based or Internet server.

The dynamic covariance matrix estimation is based on mathematical calculations. According to the notations of the mathematical calculations in the present disclosure, [symbol] ^{d} denotes a set of d-dimensional vectors in a matrix, [symbol] ^{d×p} denotes a set of d×p matrices, [symbol] ^{p} denotes a set of symmetric matrices in [symbol] ^{p×p}, [symbol] ^{p} and denotes a set of positive-semidefinite (PSD) matrices in [symbol] ^{p×p}. A vector is denoted by [N]={1, 2, . . . , N}. A matrix is denoted by X=[xᵢⱼ] ∈ [symbol] ^{d×p} which has a Frobenius norm defined as ∥X∥_{F}=√Σᵢⱼxᵢⱼ². For a square matrix, X=[xᵢⱼ]_{i,j=1}^{p}∈ [symbol] ^{p×p}, and the trace of X is defined as tr(X)=Σᵢ₌₁^{p}xᵢᵢ, and ∥X∥_{1,off} is defined as Σᵢ₌₁^{p}Σ_{j≠i}|xᵢⱼ|. For a set A, [symbol] {A} is a function such that if x ∈ A, [symbol] {A}(x)=0, otherwise [symbol] {A}(x)=∞.

The collected data can be represented by a multivariate time series {yₜ}₁^{T} with m periods and T time steps in total. Each period k ∈ [m] contains Tₖ consecutive time steps indexed by [symbol] ₖ. At each time step t, variables of interest yₜ ∈ [symbol] ^{p} of p different entities are observed. Within the same period k, yₜ can share the same covariance matrix Σₖ, i.e., Cov(yₜ, yₜ)=Σₖ for t ∈ [symbol] ₖ. Across different periods, component covariance matrices Σₖ are smoothly changing. The goal of calculations is to estimate the dynamically changing covariance matrix from the observed time series. For example, the target variables yₜ of the estimation can be asset daily returns, trading volumes or bond yields of p different companies over a certain time period. The time period could be a month, a quarter, or a year.

When the dimension of the covariance matrix is larger than a threshold, the covariance matrix can be singular which causes, because of a limited sample size, an estimation error larger than an acceptable limit. In embodiments, structural assumptions on the component covariance matrices Σₖ are included in the covariance matrix estimation to obtain results with statistically useful inferences. The structural assumptions include the assumption of sparsity in the values of the covariance matrices. This sparsity assumption may not be sufficient in applications with trends or common factors of data. For example, in financial stock markets, the stock returns can depend on the market risk or other sector-specific risks. In such examples, assuming the variables of different entities to be uncorrelated may not be realistic. Accordingly, financial factor models are further considered with the sparsity assumption in the covariance matrix estimation.

According to the factor model, the multivariate time series are defined as a sum of sparse matrix and a low rank component that is uncorrelated with the sparse matrix. The low rank component can be a product of a low rank coefficient matrix and a vector of common factors of the multivariate time series. In an embodiment, the factor model can be defined for each time period. For example, for each time period k, yₜ=Bₖfₜ+uₜ is defined for common factors fₜ ∈ [symbol] ^{r} and the coefficient matrix Bₖ ∈ [symbol] ^{p×r}, where the residual uₜ is uncorrelated with the common factors fₜ. Each component of the common factors fₜ can be a source of systematic risks, and each component of the residual uₜ can be an idiosyncratic risk of each entity. This factor model allows the decomposition of the covariance matrices as Σₖ=Bₖ Σ_{f,k} Bₖ^{T}+Σ_{u,k}, of which the first part has a rank of r«p. According to this decomposition, the assumption that Σ_{u,k} is sparse becomes more realistic, which indicates that there are a limited number of relatively stronger or substantially strong connections between the idiosyncratic risks of different entities. If Lₖ is used to denote the low-rank component Bₖ Σ_{f,k}Bₖ^{T} of the decomposition and Rₖ denotes the sparse component Σ_{u,k}, the low-rank plus sparse decomposition can be represented as Σₖ=Lₖ+Rₖ.

The structural assumptions of the component covariance matrices can also include further structural assumptions on the manner in which the covariance matrices change over time periods. The assumptions can include the assumption that k [symbol] Σₖ is smoothly changing over different periods, the assumption that both k [symbol] Lₖ and k [symbol] Rₖ are smoothly changing across time periods, and the assumption that k [symbol] Lₖ is smoothly changing over time and k [symbol] Rₖ is sparsely changing over time.

In embodiments, the low-rank part L and the sparse part R in the low-rank plus sparse decomposition Σ=L+R for the different time periods are learned simultaneously by solving a multi-period joint optimization problem defined by:

$${min}_{L , R} f ( L , R ; {S}_{k} ) = \frac{1}{2} {‖ L + R - {S}_{k} ‖}_{F}^{2} + {ρ}_{L} ( L ) + {ρ}_{R} ( R ) , \qquad ( 1 )$$

where the penalty function PL in equation (1) induces a low-rank, and ρ_{R} induces sparsity. In equation (1), Sₖ ∈ [symbol] ^{p×p} denotes the component covariance matrix of the time-series in period k. If (\hat{L}ₖ, \hat{R}ₖ) is the optimal solution to the optimization problem of equation (1), the (static) covariance estimation for the single period k is given by \hat{Σ}ₖ=\hat{L}ₖ+\hat{R}ₖ.

To obtain a low-rank matrix L, the rank of L is constrained with ρ_{L} being the corresponding indicator function. A convex penalty function can also be used by taking ρ_{L} as the nuclear norm of a matrix (i.e., the sum of singular values). For a PSD matrix L, the nuclear norm becomes the trace tr(L). The two penalties can be combined to get a more generalized regularizer:

$${ρ}_{L} ( L ) = α tr ( L ) + \{ L ∈ {𝕊}_{+}^{p} , rank ( L ) \leq \overline{r} \} . \qquad ( 2 )$$

The two penalties can be special cases of equation (2), which represents an [symbol] ₀- [symbol] ₁ type penalty that reduces overfitting in the regime of low-signal-to-noise ratios in sparse regression.

To enforce sparsity [symbol] ₁ type regularization on off-diagonal entries of R with a symmetry constraint on R can be define as:

$${ρ}_{R} ( R ) = β {‖ R ‖}_{1 , off} + \{ R ∈ {𝕊}^{p} \} , \qquad ( 3 )$$

where diagonals of R are not penalized because the diagonals of R correspond to the variances of uₜ and not the covariances between companies p. The PSD constraint on R can also be dropped for faster calculations.

To extend the single period setting to the dynamic setting, based on the optimization problem for the single period k, the optimization problem for a time-varying model can be defined by:

$${min}_{{L}_{k} , {R}_{k} , k ∈ [ m ]} {\sum }_{k = 1}^{m} f ( {L}_{k} , {R}_{k} ; {S}_{k} ) + {\sum }_{k = 1}^{m - 1} 𝒟 ( ( {L}_{k + 1} , {R}_{k + 1} ) , ( {L}_{k} , {R}_{k} ) ) , \qquad ( 4 )$$

where the discrepancy metric [symbol] (.,.) penalizes the distance between the estimates of covariances across two successive periods. In addition to looking at the loss (Lₖ, Rₖ; Sₖ) for each single period k, the objective function limits differences between the estimated covariances across each two successive periods of the time periods. The objective function in equation (4) ensures that the estimates from a (k+1)-th period are not substantially far away from the estimates from a k-th period. Depending on the nature of change, different discrepancy metrics can be selected.

In embodiments, discrepancy metrics, referred to herein as slow changes in L and R (WLR), slow change in L and slow change in R (WLWR), and slow change in L and sparse change in R (WLPR), correspond to respective structural assumptions of the component covariance matrices and are defined as:

$${𝒟}_{1} ( ( {L}_{k + 1} , {R}_{k + 1} ) , ( {L}_{k} , {R}_{k} ) ) = \frac{γ}{2} {‖ {L}_{k + 1} + {R}_{k + 1} - {L}_{k} - {R}_{k} ‖}_{F}^{2} \qquad ( WLR )$$

$${𝒟}_{2} ( ( {L}_{k + 1} , {R}_{k + 1} ) , ( {L}_{k} , {R}_{k} ) ) = \frac{γ}{2} {‖ {L}_{k + 1} - {L}_{k} ‖}_{F}^{2} + \frac{ρ}{2} {‖ {R}_{k + 1} - {R}_{k} ‖}_{F}^{2} \qquad ( WLWR )$$

$${𝒟}_{3} ( ( {L}_{k + 1} , {R}_{k + 1} ) , ( {L}_{k} , {R}_{k} ) ) = \frac{γ}{2} {‖ {L}_{k + 1} - {L}_{k} ‖}_{F}^{2} + ρ {‖ {R}_{k + 1} - {R}_{k} ‖}_{1 , off} \qquad ( WLPR )$$

where, y, ρ≥0 are regularization parameters. In the WLR, WLWR, and WLPR metrics, Frobenius norms are used on the differences to enforce the smooth changes between covariances, low-rank parts and/or sparse parts of the component covariance matrices. Regularizers of the [symbol] ₁ norms can be used on the differences to enforce the sparse changes between the sparse components of covariances.

With the different types of regularization by the WLR, WLWR, and WLPR metrics, a final objective function for the covariance matrix estimation problem with respect to [symbol] {Lₖ}₁^{m} and [symbol] {Rₖ}₁^{m} can be defined as:

$${Min}_{ℒ , ℛ} F ( ℒ , ℛ ) := \frac{1}{2} {\sum }_{k = 1}^{m} {‖ {L}_{k} + {R}_{k} - {S}_{k} ‖}_{F}^{2} + α {\sum }_{k = 1}^{m} t r ( {L}_{k} ) + β {\sum }_{k = 1}^{m} {‖ {R}_{k} ‖}_{1 , off} + {\sum }_{k = 1}^{m - 1} {D}_{1} ( ( {L}_{k + 1} , {R}_{k + 1} ) , ( {L}_{k} , {R}_{k} ) ) , \qquad ( 5 )$$

$$s . t . {L}_{k} ∈ {𝕊}_{+}^{p} , rank ( L ) \leq \overline{r} , {R}_{k} ∈ {𝕊}^{p}$$

In equation (5), when r̅=p, the rank constraint is redundant and equation (5) becomes convex. Equation (5) has an order of magnitude O(mp²) of variables and 4 hyperparameters (α, β, γ, r), which indicates that for a set of hyperparameters, the covariance matrix estimation problem is solved with about O(10⁴) to O(10⁶) variables for hundreds or thousands of companies (i.e., p˜O(10²) to O(10³)). To solve the covariance matrix estimation problem within few seconds for thousands of hyperparameter settings, a scalable algorithm suitable for such large-scale optimization problem is used.

In embodiments, a scalable algorithm based on a BCD method is used to solve the objective function for the covariance matrix estimation problem of equation (5). For example, a cyclic BCD algorithm can be used for minimizing an objective function of the form:

$$Φ ( {x}_{1} , … , {x}_{d} ) = φ ( {x}_{1} , … , {x}_{d} ) + {\sum }_{i = 1}^{d} {h}_{i} ( {x}_{i} ) , \qquad ( 6 )$$

where φ is a smooth function part of the objective function, and hᵢ can be nondifferentiable part of the objection function. The BCD algorithm updates xᵢ keeping other xⱼ's fixed, by minimizing over xᵢ as:

$${x}_{i} ← arg {min}_{y} Φ ( {x}_{< i} , y , {x}_{> i} ) , for i = 1 , … , d , \qquad ( 7 )$$

where x_{<i} and x_{>i} are the collections of xⱼ's with j<i and j>i, respectively, which updates the coordinates of the objective function in a cyclic manner.

In an embodiment, a BCD based algorithm to solve equation (5) is defined in a series of steps, such as shown in Table 1 in pseudocode format. The pseudocode can be produced into any suitable machine-executable language/code in the form of software.

TABLE 1
BCD based algorithm for solving equation (5)
Input: Data Sₖ, k ϵ [m]. Hyperparameters α, β, γ, r̅; Initialization:
Lₖ = Lₖ⁽⁰⁾, Rₖ = Rₖ⁽⁰⁾ for all k
1: for l = 0, 1, 2, ··· do
2: for k = 0, 1, 2, ... , m do
3: Lₖ ← arg min_{X}F({ [symbol] _{<k}, X, [symbol] _{<k}}, [symbol] )
4: Rₖ ← arg min_{X}F( [symbol] ,{ [symbol] _{<k}, X, [symbol] _{<k}}) (for WLR and WLWR)
5: end for
6: [symbol] < arg min_{χ} F( [symbol] , χ) (for WLPR)
7: end for

In the BCD based algorithm for solving equation (5), the update in line 4 is for the structural assumptions of the WLR and WLWR metrics, and the update in line 6 is with the structural assumptions of WLPR. For the structural assumptions of WLR and WLWR metrics, the corresponding discrepancy metrics [symbol] ₁ and [symbol] ₂ are smooth with regard to Lₖ and Rₖ, respectively. Equation (5) can be an instance of equation (6) with L₁, R₁, . . . , Lₘ, Rₘ as 2 m blocks,

$$φ ( ℒ , ℛ ) = \frac{1}{2} {\sum }_{k = 1}^{m} {‖ {L}_{k} + {R}_{k} - {S}_{k} ‖}_{F}^{2} + \frac{γ}{2} {\sum }_{k = 1}^{m - 1} {‖ {L}_{k + 1} - {L}_{k} ‖}_{F}^{2} , {h}_{L , k} ( {L}_{k} ) = {ρ}_{L} ( {L}_{k} ) , and {h}_{ℛ} ( ℛ ) = {\sum }_{k = 1}^{m} {ρ}_{ℛ} ( {ℛ}_{k} ) + ρ {‖ {R}_{k + 1} - {R}_{k} ‖}_{1 , off} .$$

Applying equation (7) to equation (5) yields the updates in lines 3 and 4, respectively, of the BCD based algorithm.

Lines 3, 4 and 6 of the BCD based algorithm represent a minimization problem that can be solved by closed-form expressions or dynamic programming. For example, an optimization problem with a closed-form expression referred to as a soft-thresholding operator can be represented by:

$${𝒥}_{1} ( \tilde{x} ; λ ) := arg {min}_{y} \frac{1}{2} {( y - \tilde{x} )}^{2} + λ \vert y \vert = sign ( \tilde{x} ) {( \vert \tilde{x} \vert - λ )}_{+} . \qquad ( 8 )$$

A second operator can also be represented by:

$${𝒥}_{*} ( \tilde{X} ; λ , \overline{r} ) := arg {min}_{Y ∈ {𝕊}_{+}^{p}} \frac{1}{2} {‖ Y - \tilde{X} ‖}_{F}^{2} + λ tr ( Y ) , s . t . rank ( Y ) \leq \overline{r .} \qquad ( 9 )$$

Based on an eigenvalue decomposition of \tilde{X}=U\tilde{D}U^{T}, where D=diag (\tilde{d}₁, . . . , \tilde{d}ₚ) with \tilde{d}₁≥ . . . ≥\tilde{d}ₚ, the solution to equation (9) can be obtained by [symbol] (\tilde{X}; λ, r)=UD*U^{T}, where D*=diag (d*₁, . . . , d*ₚ) with d*ᵢ=(\tilde{d}ᵢ−λ)₊, ∀i >r.

The two operators of equation (8) and equation (9) can be used to obtain the updates in lines 3 and 4, respectively, of the BCD based algorithm. For the structural assumptions of WLWR and k ∉ {0, m}, the update in line 3 is equivalent to:

$${L}_{k} = arg {min}_{X \geq 0} \frac{1 + 2 γ}{2} {‖ X - {\tilde{L}}_{k} ‖}_{F}^{2} + α tr ( X ) , s . t . rank ( X ) \leq \overline{r} = {𝒥}_{*} ( {\tilde{L}}_{k} ; \frac{α}{1 + 2 γ} , \overline{r} ) , \qquad ( 10 )$$

where

$${\tilde{L}}_{k} = \frac{1 + 2 γ}{2} [ ( {S}_{k} - {R}_{k} ) + γ {L}_{k + 1} + γ {L}_{k - 1} ] .$$

The update is line 4 is equivalent to:

$${R}_{k} = {arg min}_{X ∈ {𝕊}^{𝓅}} \frac{1 + 2 γ}{2} {‖ X - {\tilde{R}}_{k} ‖}_{F}^{2} + β {‖ X ‖}_{1 , off} , \qquad ( 11 )$$

where

$${\tilde{R}}_{k} = \frac{1}{1 + 2 γ} [ ( {S}_{k} - {R}_{k} ) + γ {R}_{k + 1} + γ {R}_{k - 1} ] .$$

Since ∥X ∥_{1,off} is separable with regard to each component of X, the minimization problem of equation (11) can be solved separately over each component, where each problem is in the form of equation (8). Accordingly, the solution of equation (11) is represented by X* with

$${X}_{ij}^{*} = {X}_{ji}^{*} = {𝒯}_{1} ( {\tilde{R}}_{k , ij} ; \frac{β}{1 + 2 γ} ) , ∀ i < j ; {X}_{ii}^{*} = {\tilde{R}}_{k , ii} , ∀ i ∈ [ 𝓅 ] .$$

For the structural assumptions of the WLR metric and k ∈ {0, m}, the updates in line 3 and line 4 are similar to the updates for the structural assumptions of WLWR. For the structural assumptions of the WLR metric, it is also useful to keep track of the residuals defined by Eₖ=Lₖ+Rₖ−Sₖ and Dₖ=Lₖ₊₁+Rₖ₊₁−Lₖ−Rₖ to reduce the calculations in each update and improve calculation time efficiency.

For the structural assumptions of WLPR, the update in line 3 is similar to that of the WLR metric. The updates in line 6 is equivalent to:

$$ℛ = arg {min}_{x} \frac{1}{2} {‖ {X}_{k} + {L}_{k} - {S}_{k} ‖}_{F}^{2} + {\sum }_{k = 1}^{m} β {‖ {X}_{k} ‖}_{1 , off}$$

$${\sum }_{k = 1}^{m - 1} β {‖ {X}_{k + 1} - {X}_{k} ‖}_{1 , off} . \qquad ( 12 )$$

For i≤j and any {Yₖ}₁^{m}, and Y ij denoting the vector of {Y_{k,ij}}₁^{m}, the objective of equation (12) can be represented by Σᵢ₌₁^{p}gᵢᵢ(X_{.,ii})+2Σ_{i<j}gᵢⱼ(X_{.,ij}), where

$${g}_{ii} ( x ) = \frac{1}{2} {‖ x + {L}_{. , ii} - {S}_{. , ii} ‖}^{2} and \qquad ( 13 )$$

$${g}_{ij} ( x ) = \frac{1}{2} {‖ x + {L}_{. , ij} - {S}_{. , ij} ‖}^{2} + β {‖ x ‖}_{1} + ρ {\sum }_{k = 1}^{m - 1} \vert {x}_{k + 1} - {x}_{k} \vert , \qquad ( 14 )$$

which can be solved separately. For example, equation (14) can be solved efficiently on an order of magnitude O(m) by dynamic programming.

The convergence property of the BCD based algorithm can be examined according to a theorem where ( [symbol] , [symbol] ) is the [symbol] -th iteration of ( [symbol] , [symbol] ) in the BCD based algorithm, and accordingly F( [symbol] , [symbol] )≤F( [symbol] , [symbol] ). When r̅=p, i.e., there is no rank constraint, then the optimization problem becomes convex and a number of conditions hold. According to a first condition, any limiting point of {( [symbol] , [symbol] )}₁^{∞} is a global minimum of the problem. According to a second condition, a constant C>0 exists, such that

$$F ( {ℒ}^{( ℓ )} , {ℛ}^{( ℓ )} ) - {F}^{*} \leq \frac{c}{ℓ} ,$$

where F* is the optimal value of equation (5). The conditions hold for the structural assumptions of the WLR, WLWR, and WLPR metrics.

In embodiments, the estimated dynamic covariance matrix, which is estimated using the BCD based algorithm to solve the objective function of equation (5), can be in turn used to optimize an application. For example, if the application is a finance application, the estimated dynamic covariance matrix can be used to optimize a portfolio by optimizing an objective, such as maximizing expected returns and/or minimizing variances of returns. The objective can be a function of the target variables yₜ of the dynamic covariance matrix, such as asset daily returns, trading volumes, or bond yields of p different companies over different time periods.

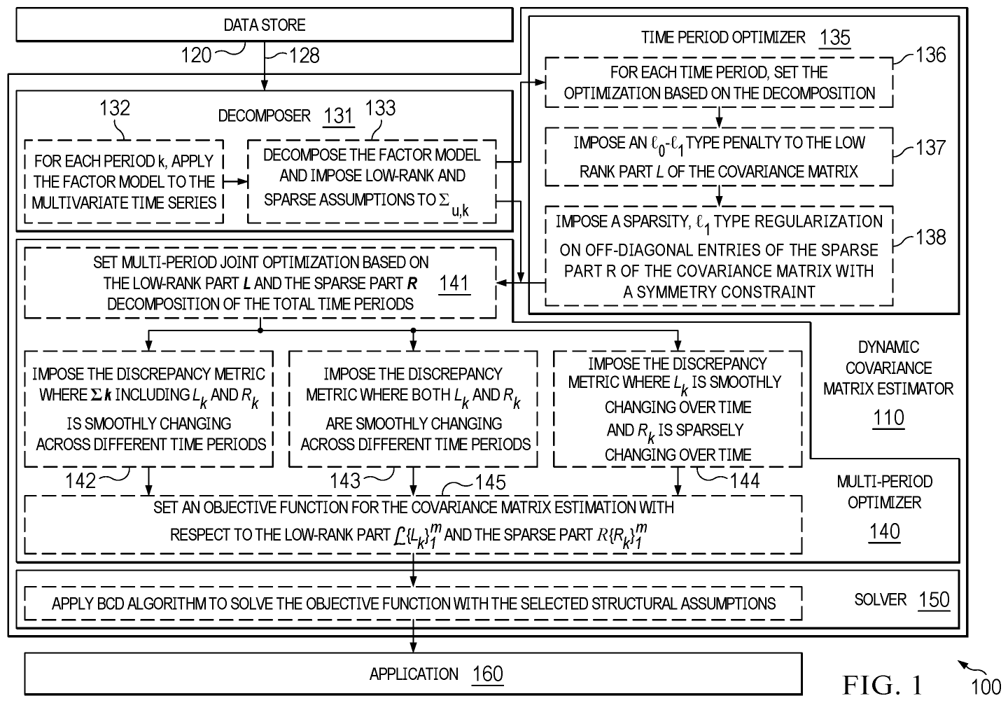

FIG. 1 is a block diagram illustration of a system 100 for dynamic covariance matrix estimation, according to embodiments of the disclosure. The system 100 is configured to solve a joint optimization problem by simultaneously learning component covariance matrices of a dynamic covariance matrix using scalable algorithms. The component covariance matrices can be static covariance matrices. The joint optimization solution also includes structural assumptions for the component covariance matrices, such as low-rank and sparsity, and further assumptions using regularizers that control the amount of change in the values of the covariances over time periods.

The system 100 includes a dynamic covariance matrix estimator 110 configured to implement the joint optimization, and a data store 120 coupled to the dynamic covariance matrix estimator 110. For example, the dynamic covariance matrix estimator 110 can be implemented as software on a computer system or environment. The data store 120 can be coupled to the dynamic covariance matrix estimator 110 locally such as a storage device for a computer system, or remotely such as a cloud based or Internet connected storage system for a computer environment. The data store 120 includes data collected for one or more applications, such as in finance, economics, biology, machine learning, social networks, health sciences, or other applications. In examples, the data is economics data, finance data, economics data, health data, marketing data, science data, social networks data, energy data, behavioral science data, or other data for other applications.

If the data store 120 is remotely connected to the dynamic covariance matrix estimator 110, the dynamic covariance matrix estimator 110 can receive the data from the data store 120 though data connectors 128 for interfacing between the dynamic covariance matrix estimator 110 and the data store 120. For example, the dynamic covariance matrix estimator 110 can receive data from the data store 120 through the Internet using application programming interfaces (APIs). The data can be multivariate time series which are used by the dynamic covariance matrix estimator 110 to perform dynamic covariance matrix estimation based on the joint optimization of the component covariance matrices. The dynamic covariance matrix estimator 110 includes modules corresponding to steps of the optimization process. The modules can be implemented as software components or code blocks in a software.

The modules of the dynamic covariance matrix estimator 110 include a decomposer 131 configured to perform a regularizer function 132 to apply a factor model to the multivariate time series for each time period k of the multivariate time series. The factor model is based on the data and the applications. The decomposer receives the multivariate time series as input from the data store 120. For example, for finance data, the factor model represents risk associated with assets or finance data. The factor model can be defined by decomposing the covariance matrix for each time period k as yₜ=Bₖfₜ+uₜ with a vector of common factors fₜ, a coefficient matrix Bₖ, and a vector or residuals uₜ uncorrelated with the common factors in fₜ. Each component of fₜ can be a source of systematic risks, and each component of uₜ can be a respective idiosyncratic risk. The decomposer 131 also performs a decomposition function 133 to decompose the factor model and impose low rank and sparse assumptions to the sparse component Σ_{u,k} of the decomposition for each time period k. The covariance matrix yₜ for each time period k can be decomposed according to a low-rank part Bₖfₜ and a sparse part uₜ. A static covariance matrix for each time period k can be decomposed by the low-rank plus sparse decomposition Σₖ=Lₖ+Rₖ.

The dynamic covariance matrix estimator 110 also includes a time period optimizer 135. The time period optimizer 135 is configured to perform an optimization function 136 to set the optimization for each time period based on the decomposition of the decomposer 131. The optimization can be set according to equation (1) as

$${min}_{L , R} f ( L , R ; {S}_{k} ) = \frac{1}{2} {‖ L + R - {S}_{k} ‖}_{F}^{2} + {ρ}_{L} ( L ) + {ρ}_{R} ( R ) .$$

The time period optimizer 135 performs a penalty function 137 to impose an [symbol] ₀- [symbol] ₁ type penalty to the low-rank part L of the covariance matrix. The [symbol] ₀- [symbol] ₁ type penalty reduces overfitting in the regime of low-signal-to-noise ratios in sparse regression and can be imposed according to equation (2) as ρ_{L}(L)=α tr(L)+ [symbol] {L ∈ [symbol] ₊^{p}, rank (L)≤r̅}. The time period optimizer 135 also performs a regularization function 138 to impose a sparsity [symbol] ₁ type regularization on off-diagonal entries of the sparse part R of the covariance matrix with a symmetry constraint. The sparsity [symbol] ₁ type regularization can be imposed according to equation (3) as ρ_{R}(R)=β∥R∥_{1,off}+ [symbol] {∈ [symbol] ^{p}}.

A multi-period optimizer 140 of the dynamic covariance matrix estimator 110 is configured to perform an optimization function 141 to set multi-period joint optimization based on the low-rank part L and the sparse part R decomposition of the total number of time periods from the time period optimizer 135. The multi-period joint optimization can be set according to equation (4) as

$${min}_{{L}_{k} , {R}_{k} , k ∈ [ m ]} {\sum }_{k = 1}^{m} f ( {L}_{k} , {R}_{k} ; {S}_{k} ) + {\sum }_{k = 1}^{m - 1} 𝒟 ( ( {L}_{k + 1} , {R}_{k + 1} ) , ( {L}_{k} , {R}_{k} ) ) .$$

The multi-period joint optimization includes a discrepancy metric [symbol] ( . , . ) that penalizes the distance between the estimates across two successive periods. The discrepancy metric corresponds to structural assumptions of the component covariance matrices. The structural assumptions for the discrepancy metric can be selected from multiple structural assumptions.

According to first structural assumptions 142, the multi-period optimizer 140 imposes the discrepancy metric where the low-rank plus sparse decomposition Σₖ including the low-rank part Lₖ and the sparse part Rₖ is smoothly changing across different time periods. The discrepancy metric is imposed according to

$${𝒟}_{1} ( ( {L}_{k + 1} , {R}_{k + 1} ) , ( {L}_{k} , {R}_{k} ) ) = \frac{γ}{2} {‖ {L}_{k + 1} + {R}_{k + 1} - {L}_{k} - {R}_{k} ‖}_{F}^{2}$$

for the WLR metric. According to second structural assumptions 143, the multi-period optimizer 140 imposes the discrepancy metric where both the low-rank part Lₖ and the sparse part Rₖ are smoothly changing across different periods. The discrepancy metric is imposed according to

$${{𝒟}_{2} ( ( {L}_{k + 1} , {R}_{k + 1} ) , ( {L}_{k} , {R}_{k} ) ) = \frac{γ}{2} {‖ {L}_{k + 1} - {L}_{k} ‖}_{F}^{2} + \frac{ρ}{2} ‖ {R}_{k + 1} - {R}_{k} ‖}_{F}^{2}$$

for WLWR. According to third structural assumptions 144, the multi-period optimizer 140 imposes the discrepancy metric where the low-rank part Lₖ is smoothly changing over time and the sparse part Rₖ is sparsely changing over time. The discrepancy metric is imposed according to

$${{𝒟}_{3} ( ( {L}_{k + 1} , {R}_{k + 1} ) ( {L}_{k} , {R}_{k} ) ) = \frac{γ}{2} {‖ {L}_{k + 1} - {L}_{k} ‖}_{F}^{2} + ρ ‖ {R}_{k + 1} - {R}_{k} ‖}_{1 , off}$$

### for WLPR.

The multi-period optimizer 140 includes a next operation 145 configured to set an objective function for the covariance matrix estimation problem with respect to the low-rank part [symbol] {Lₖ}₁^{m} and the sparse part [symbol] {Rₖ}₁^{m}. The objective function for the covariance matrix estimation is set with the selected discrepancy of one of the structural assumptions 142, 143, and 144 according to equation (5) as

$${Min}_{ℒ , R} F ( ℒ , R ) := \frac{1}{2} {\sum }_{k = 1}^{m} {‖ {L}_{k} + {R}_{k} - {S}_{k} ‖}_{F}^{2} + α {\sum }_{k = 1}^{m} tr ( {L}_{k} ) + β {\sum }_{k = 1}^{m} {‖ {R}_{k} ‖}_{1 , off} + {\sum }_{k = 1}^{m - 1} {𝒟}_{1} ( ( {L}_{k + 1} , {R}_{k + 1} ) , ( {L}_{k} , {R}_{k} ) ) , s . t . {L}_{k} ∈ {𝕊}_{+}^{𝓅} , rank ( L ) \leq \overline{r} , {R}_{k} ∈ {𝕊}^{𝓅} .$$

The dynamic covariance matrix estimator 110 also includes a solver 150 configured to apply a BCD algorithm to solve the objective function with the selected structural assumptions. Accordingly, the dynamic covariance matrix estimation process is completed producing an estimated dynamic covariance matrix for the multivariate time series. For example, the module 150 can implement the BCD based algorithm in Table 1. Accordingly, if the assumptions are set by the module 142 for the WLWR or WLR metric, then the objective function is solved by the module 150 according to equation (10) as

$$arg {min}_{X \geq 0} \frac{1 + 2 γ}{2} {‖ X - {\tilde{L}}_{k} ‖}_{F}^{2} + α tr ( X ) , s . t . rank ( X ) \leq \overline{r} = {𝒯}_{*} ( {\tilde{L}}_{k} ; \frac{α}{1 + 2 γ} , \overline{r} ) , and {R}_{k} = arg {min}_{X ∈ {𝕊}^{𝓅}} \frac{1 + 2 γ}{2} ‖ X - {{{\tilde{R}}_{k} ‖}_{F}^{2} + β ‖ X ‖}_{1 , off} .$$

If the assumptions are set by the module 143 for WLPR, then the objective function is solved by the module 150 according to equation (12) as

$$ℛ = arg {min}_{x} \frac{1}{2} {‖ {X}_{k} + {L}_{k} - {S}_{k} ‖}_{F}^{2} + {\sum }_{k = 1}^{m} β {‖ {X}_{k} ‖}_{1 , off} , and {\sum }_{k = 1}^{m - 1} β {‖ {X}_{k + 1} - {X}_{k} ‖}_{1 , off} .$$

In examples, the objective function solution for the dynamic covariance matrix using the BCD algorithm (by the solver 150) with the low-rank plus sparse decomposition (of the optimization function 141) and with time-varying characteristic assumptions (of functions 142-144) can provide a convergence property faster (e.g., by up to 100 times) than off-the-shelf solvers.

The system 100 can also include an application 160 configured to use the estimated dynamic covariance matrix from the dynamic covariance matrix estimator 110. The application 160 can be an application that processes data using the estimated covariance matrix from the solver 160 to provide an output of the application 160. For example, the application 160 is configured to decorrelate, identify dependencies, or transform input data into output data based on the estimated dynamic covariance matrix. Examples of the application 160 include engineering applications, biology, genomics or other medical/health applications, social networking applications, game or other entertainment applications, image/speech recognition or other machine learning applications, economics or finance applications, or other applications.

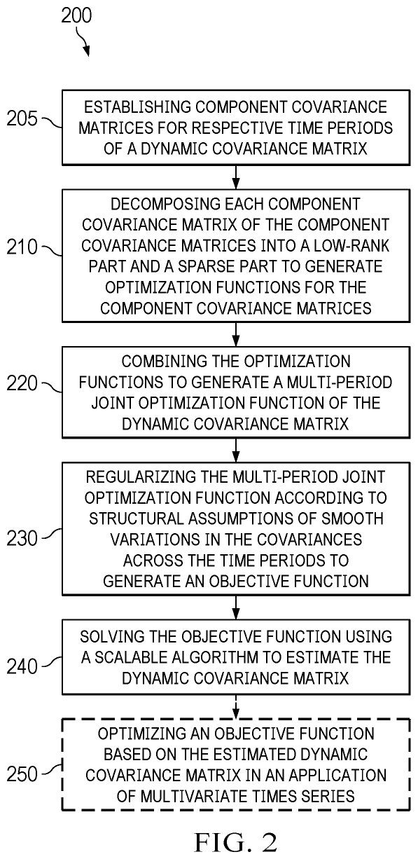

FIG. 2 is a flow diagram illustrating a method 200 for dynamic covariance matrix estimation, according to embodiments of the disclosure. For example, the method 200 can be performed by the dynamic covariance matrix estimator 110 executed as software on a computer system or environment. The method 200 includes, at block 205, establishing component covariance matrices respectively for time periods of the dynamic covariance matrix. Each component covariance matrix of the component covariance matrices can be a static covariance matrix of stationary covariances that do not change significantly in a respective time period of the time periods. At block 210, the method 200 includes decomposing each component covariance matrix of the component covariance matrices into a low-rank part and a sparse part to generate optimization functions of the component covariance matrices. For example, the decomposer 131 applies (in the regularizer function 132) a factor model to the multivariate time series for each time period, and decomposes (in the decomposition function 133) the factor model into a low-rank part and a sparse part.

At block 220, the method 200 includes combining the optimization functions to generate a multi-period joint optimization function of the dynamic covariance matrix. For example, the multi-period optimizer 140 performs the optimization function 141 that sets multi-period joint optimization based on the low-rank part and the sparse part decomposition of the total number of time periods according to equation (4).

At block 230, the method 200 includes regularizing the multi-period joint optimization function according to structural assumptions of smooth variations in the covariances across the time periods to generate an objective function. For example, the multi-period optimizer 140 performs the operation 145 that sets an objective function for the covariance matrix estimation problem with respect to the low-rank part and the sparse part, including a discrepancy metric of one of the structural assumptions 142, 143, and 144 according to equation (5).

At block 240, the method 200 includes solving the objective function using a scalable algorithm to estimate the dynamic covariance matrix. In an embodiment, the scalable algorithm is a BCD based algorithm. For example, the solver 150 applies the BCD algorithm to solve the objective function with the selected structural assumptions to obtain the estimated dynamic covariance matrix for the multivariate time series according to equation (10). The objective function is solved to estimate the component covariance matrices as static covariance matrices of the time series simultaneously with structural and time-varying characteristics assumptions of the component covariance matrices. The objective function is also solved by estimating the component covariance matrices with higher estimation accuracy and calculation time efficiency compared to estimating the dynamic covariance matrix as single covariance matrix across the time periods. The objective function is solved using a BCD based algorithm with faster time on an order of multiple magnitudes (e.g., up to 100 times) than other estimation algorithms that use parametric or non-parametric/semi-parametric models. In embodiments, the method 200 further includes, at a block 250, optimizing an objective function based on the estimated dynamic covariance matrix in an application (e.g., application 160) of the multivariate times series.

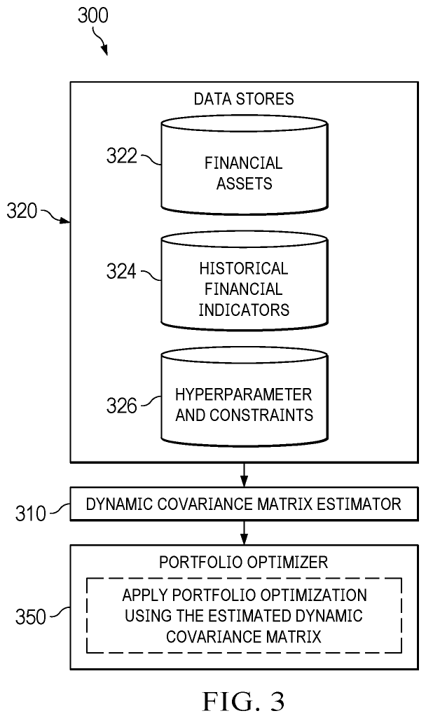

In an embodiment, the application is a finance application for optimizing a portfolio of investments in financial assets. FIG. 3 is a block diagram illustration of a system 300 for optimizing a portfolio using dynamic covariance matrix estimation, according to embodiments of the disclosure. The system 300 is configured to optimize a portfolio of investments using an estimated dynamic covariance matrix of multivariate time series of finance data. The system 300 includes a dynamic covariance matrix estimator 310 configured to estimate the dynamic covariance matrix, and data stores 320 coupled to the dynamic covariance matrix estimator 310.

The dynamic covariance matrix estimator 310 can be implemented using software on a computer system to solve a joint optimization problem of the dynamic covariance matrix. The dynamic covariance matrix estimator 310 can be configured similar to the dynamic covariance matrix estimator 110 of system 100. The data stores 320 of system 300 can be coupled to the dynamic covariance matrix estimator 310 locally or remotely and maintain finance data collected for different entities (e.g., companies) and different time periods (e.g., days, months, quarters, or years). The finance data can include data of financial assets 322, historical financial indicators 324, and hyperparameters and constraints 326 which are useful for the joint optimization calculations of a dynamic covariance matrix for different time periods.

The system 300 also includes a portfolio optimizer 350 configured to apply portfolio optimization using the estimated dynamic covariance matrix from the dynamic covariance matrix estimator 310. The portfolio optimization is an optimization of a function of the estimated dynamic covariance matrix. In an embodiment, a portfolio optimization problem with an objective to minimize variances, also referred to as a minimum variance portfolio problem, can be defined and solved by the portfolio optimizer 350 using:

$${min}_{w} {w}^{T} \hat{\sum } w , s . t . {1}^{T} w = 1 , w \geq 0 , \qquad ( 15 )$$

where \hat{Σ} is an estimate of the covariance of returns and w is the portfolio.

The quality of portfolio w can be evaluated using metrics defined based on the predicted volatility σ²[w]=w^{T}S^{train}w and the realized volatility \hat{σ}²[w]=w^{T}s^{test}w, where S^{train} is the sample covariance matrix in the training period and S^{test} is the sample covariance matrix in the testing period. The metrics include a first metric R_{σ} defined as |σ[w]-\hat{σ}[w]|/σ[w] which is a measure of the reliability of the portfolio in predicting the true realized volatility out-of-sample from the predicted volatility in-sample. A small R_{σ} value means that the portfolio's out-of-sample risk is close to the in-sample risk. A second metric is the realized volatility \hat{σ}[w] out-of-sample, which is a measure of risk of portfolio and is the target metric to minimize in the portfolio optimization problem of equation (15).

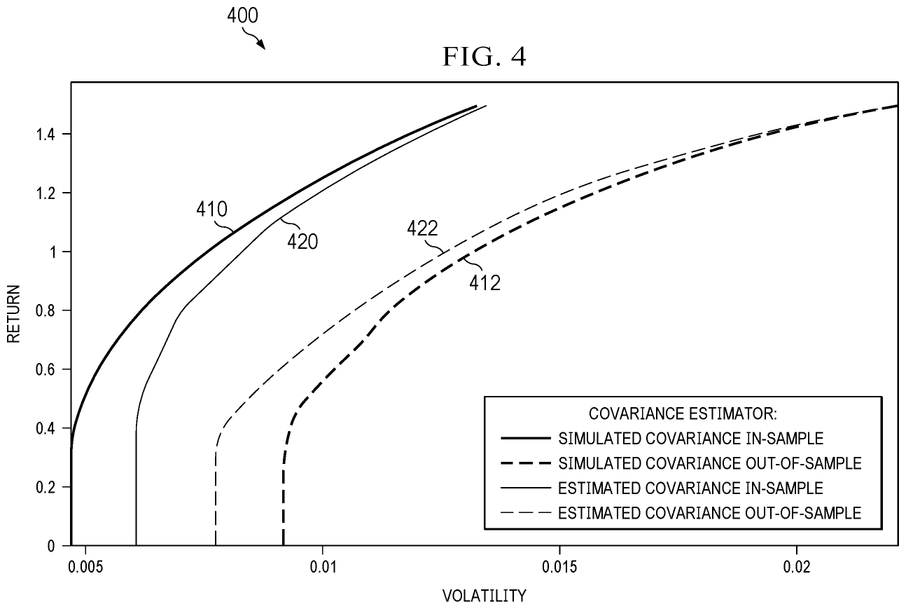

FIG. 4 is a graph illustrating volatility-return curves 400 for different values of expected return of a portfolio, according to embodiments of the disclosure. The volatility-return curves 400 illustrate the reliability (R_{σ}) and realized volatility (\hat{σ}[w]) of portfolio w in equation (15). The volatility-return curves 400 are generated by calculating the volatility for different values of an expected return variable r̅. The calculations are obtained by solving the portfolio optimization problem of equation (15) with an additional constraint Σᵢ₌₁^{p}μᵢwᵢ≥r̅. The volatility-return curves 400 include a risk-return curve 410 for the sample covariance matrix in-sample, a risk-return curve 412 for the sample covariance matrix out-of-sample, a risk-return curve 420 for the estimated covariance matrix in-sample, and a risk-return curve 422 for the estimated covariance matrix out-of-sample 422. The dynamic covariance matrix is estimated with the structural assumptions of WLPR. The return and volatility values in the curves 400 are annualized and for the Efficient Frontier for the S&P500 during the last quarter of 2015. The values of expected return of the portfolio are assumed to be stationary over time.

FIG. 4 shows a distance between the risk-return curve 420 of the portfolio for the estimated covariance matrix in-sample and the risk-return curve 422 out-of-sample. The reliability metric Ro is a measure of how close the in-sample risk-return curve 420 and the out-of-sample risk-return curve 422 are. The shorter distance (smaller R_{σ}) between the curves 420 and 422 of the estimated covariances, in comparison to the curves 410 and 412 of the sample covariances, indicates that the dynamic covariance matrix estimation (based on WLPR in this example) improves reliability in predicting the true realized volatility out-of-sample from the predicted volatility in-sample. The out-of-sample curve 422 for the estimated covariance matrix is also higher than the out-of-sample curve 420 for the sample covariance matrix which indicates that the dynamic covariance matrix estimation also improves out-of-sample volatility.

The difference between the estimated volatility for in sample and out-of-sample can be caused by the statistical uncertainty and the presence of noise, such as when using a small number of observations. In order to mitigate this effect, the sample size can be increased to use more observations. The difference can also be caused by assuming that the correlation structures are stationary which is not always true. The dynamic covariance estimation methods according to the embodiments of the disclosure can provide a balance between using regularization to mitigate noise (or limited sample size) and allowing for correlation structures to change across time.

In other embodiments, the estimated dynamic covariance matrix is used in applications other than finance applications. In an embodiment, the estimated dynamic covariance matrix (e.g., by the dynamic covariance matrix estimator 110 or by the method 200) is used in a biology/health science application (e.g., application 160) to evaluate a model for dynamic functional brain network connectivity. The dynamic covariance matrix is estimated with brain neuroimages collected using functional magnetic resonance imaging (MRI), and the brain functions are modeled as a function of the estimated dynamic covariance matrix as interactions between cognitive processes. In another embodiment, the estimated dynamic covariance matrix is used in a text mining/topic modeling application to examine texts and identify evolving correlations between topics in the texts. The modeling is based on a function of a dynamic covariance matrix that is estimated using text mining data. In yet another embodiment, the estimated dynamic covariance matrix is used in an application for environmental informatics to detect trends among disparate variables from the atmosphere or the biosphere. An estimated dynamic covariance matrix of atmospheric data is used to model the environment trends. In further embodiments, the estimated dynamic covariance matrix is used in various applications for optimizing objective functions of a time-varying covariance matrix with non-stationary multivariate time series.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

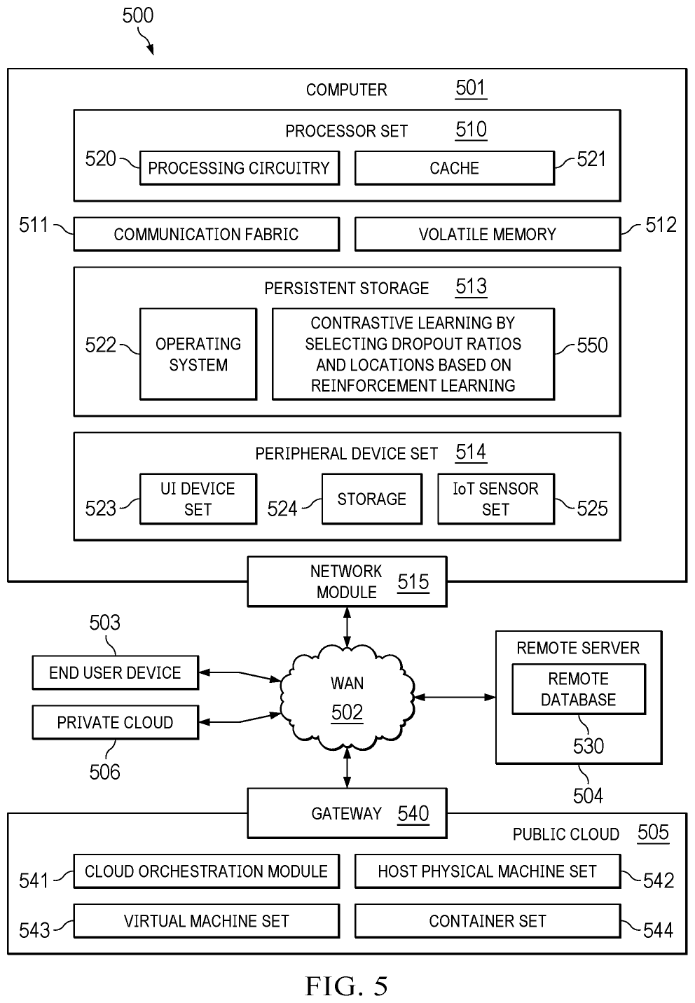

FIG. 5 is a block diagram illustration of a hardware architecture of a computing environment 500, according to embodiments of the disclosure. Computing environment 500 contains an example of an environment for the execution of at least some of the computer code involved in performing the inventive methods, such as dynamic covariance matrix estimation module 550. In addition to module 550, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and module 550, as identified above), peripheral device set 514 (including user interface (UI) device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in module 550 in persistent storage 513.

COMMUNICATION FABRIC 511 is the signal conduction path that allows the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, volatile memory 512 is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface-type operating systems that employ a kernel. The code included in module 550 typically includes at least some of the computer code involved in performing the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, user interface (UI) device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. Internet of Things (IoT) sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN 502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, central processing unit (CPU) power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. Further, the steps of the methods described herein may be carried out in any suitable order, or simultaneously where appropriate. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for estimating a dynamic covariance matrix, comprising:
establishing component covariance matrices respectively for time periods of the dynamic covariance matrix;
decomposing each component covariance matrix of the component covariance matrices into a low-rank part and a sparse part to generate optimization functions of the component covariance matrices;
combining the optimization functions to generate a multi-period joint optimization function of the dynamic covariance matrix;
regularizing the multi-period joint optimization function according to structural assumptions of smooth variations in covariances across the time periods to generate an objective function; and
solving the objective function using a scalable algorithm to estimate the dynamic covariance matrix.

2. The method of claim 1, wherein decomposing each component matrix comprises:
applying a factor model to multivariate time series for each time period of the time periods; and
decomposing the factor model into the low-rank part and the sparse part.

3. The method of claim 2, wherein, according to the factor model, the multivariate time series are defined as a sum of sparse matrix and a low rank component that is uncorrelated with the sparse matrix.

4. The method of claim 3, wherein the low rank component is a product of a low rank coefficient matrix and a vector of common factors of the multivariate time series.

5. The method of claim 1, wherein the scalable algorithm is a block coordinate descent (BCD) based algorithm.

6. The method of claim 1, wherein each component covariance matrix of the component covariance matrices is a static covariance matrix of stationary covariances that do not change significantly in a respective time period of the time periods.

7. The method of claim 1 further comprising optimizing an application objective function of multivariate times series based on the estimated dynamic covariance matrix.

8. A system, comprising:
a non-transitory computer-readable storage memory configured to store instructions; and
a processor coupled to the non-transitory computer-readable storage memory and configured to execute the instructions to cause the system to:
generate optimization functions of component covariance matrices for respective time periods based on a factor model of multivariate time series including a low-rank part and a sparse part;
combine the optimization functions to generate a multi-period joint optimization function of a dynamic covariance matrix across the time periods;
generate an objective function by regularizing the multi-period joint optimization function according to structural assumptions of smooth changes across the time periods; and
estimate the dynamic covariance matrix by solving the objective function using a scalable algorithm.

9. The system of claim 8, wherein the processor is further configured to impose a penalty to the low-rank part to reduce overfitting for values in a range of low-signal-to-noise ratios in sparse regression.

10. The system of claim 8, wherein the processor is further configured to impose a sparsity type regularization on off-diagonal values of the sparse part with a symmetry constraint.

11. The system of claim 8, wherein the processor is further configured to execute the instructions to regularize the multi-period joint optimization function using a regularizer that controls a change in covariances over the time periods, and wherein the regularizer is a discrepancy metric defined based on the structural assumptions to enforce the smooth changes between the covariances.

12. The system of claim 11, wherein the processor is further configured to select the discrepancy metric from different discrepancy metrics of multiple structural assumptions depending on the change in covariances over the time periods.

13. The system of claim 8, wherein the structural assumptions include structural assumptions that a low-rank plus sparse decomposition including the low-rank part and the sparse part is smoothly changing over different time periods, structural assumptions that both the low-rank part and the sparse part are smoothly changing over different time periods, and structural assumptions that the low-rank part is smoothly changing over time and the sparse part is sparsely changing over time.

14. The system of claim 8, wherein the scalable algorithm is a cyclic block coordinate descent (BCD) algorithm, and wherein the processor is further configured to minimize, using the cyclic BCD, the objective function including a smooth function part and a nondifferentiable part by updating coordinates of the objective function in a cyclic manner.

15. A computer program product comprising instructions stored on a computer-readable medium that, when executed by a processor, cause a system to:
receive data of time series for different time periods;
generate optimization functions of component covariance matrices of the time series, wherein each of the component covariance matrices is decomposed into a low-rank part and a sparse part for a respective time period of the time periods;
generate a multi-period joint optimization function of a dynamic covariance matrix as a combination the optimization functions;
impose a discrepancy metric on the multi-period joint optimization function according to structural assumptions of smooth changes across the time periods to obtain an objective function for the dynamic covariance matrix; and
solve the objective function using a block coordinate descent (BCD) based algorithm to estimate the dynamic covariance matrix.

16. The computer program product of claim 15, wherein the instructions further cause the system to optimize a function of the dynamic covariance matrix for an application of multivariate time series.

17. The computer program product of claim 16, wherein the application is a finance or economics application, a science application, a social network application, or a machine learning application.

18. The computer program product of claim 15, wherein the instructions further cause the system to solve the objective function by estimating the component covariance matrices as static covariance matrices of the time series simultaneously with structural and time-varying characteristics assumptions of the component covariance matrices.

19. The computer program product of claim 15, wherein the instructions further cause the system to solve the objective function by estimating the component covariance matrices with higher estimation accuracy and calculation time efficiency compared to estimating the dynamic covariance matrix as single covariance matrix across the time periods.

20. The computer program product of claim 15, wherein the instructions further cause the system to solve the objective function using the BCD based algorithm with faster time on an order of multiple magnitudes than other estimation algorithms that use parametric or non-parametric/semi-parametric models.
